(19) United States
(12) Patent Application Publication
(10) Pub. No.: US 2024/0141135 A1
(43) Pub. Date: May 2, 2024

(54) RESIN-BASED MATERIALS FOR USE IN WELLBORE OPERATIONS

(71) Applicant: Halliburton Energy Services, Inc., Houston, TX (US)

(72) Inventors: Paul J. JONES, Houston, TX (US); Giorgio DEVERA, Houston, TX (US); Samuel J. LEWIS, Houston, TX (US)

(73) Assignee: Halliburton Energy Services, Inc., Houston, TX (US)

(21) Appl. No.: 17/977,700

(22) Filed: Oct. 31, 2022

(51) Int. Cl. C08K 3/38; C08G 59/24; C08G 59/50; C09K 8/44; E21B 41/00

(52) U.S. Cl. CPC C08K 3/38; C08G 59/245; C08G 59/5033; C09K 8/44; E21B 41/00; C08K 2003/385; C08K 2201/011

(57) ABSTRACT

Methods and compositions for performing a wellbore operation in a subterranean formation. An example method introduces a resin-based material into a wellbore. The resin-based material is a resin and a boron nitride nanotube structure comprising a boron nitride nanotube having a hexagonal boron nitride structure epitaxial to the boron nitride nanotube. The example method performs the wellbore operation in the wellbore with the resin-based material.

### TECHNICAL FIELD

The present disclosure relates generally to using resin-based materials for sealing operations as well as for the construction of wellbore tools, and more particularly, to the inclusion of a boron nitride nanotube structure having hexagonal boron nitride structures epitaxial to the boron nitride nanotube to in a resin to improve the characteristics of the resin for sealing operations as well as for the construction of wellbore tools.

### BACKGROUND

Resin-based materials may be used in a variety of subterranean operations. For example, in subterranean well construction, a pipe string (e.g., casing, liners, expandable tubulars, etc.) may be run into a wellbore and cemented in place. The process of cementing the pipe string in place is commonly referred to as “primary cementing.” In a typical primary cementing method, a cement may be pumped into an annulus between the walls of the wellbore and the exterior surface of the pipe string disposed therein. The cement composition may set in the annular space, thereby forming an annular sheath of hardened, substantially impermeable resin (i.e., a cement sheath) that may support and position the pipe string in the wellbore and may bond the exterior surface of the pipe string to the subterranean formation. A resin-based sealant may be used in place of the cement for cementing operations to form a resin sheath instead of a cement sheath. The resin sheath surrounding the pipe string functions to prevent the migration of fluids in the annulus, as well as to protect the pipe string from corrosion. Resin-based materials may also be used in remedial cementing methods, for example, to seal cracks or holes in pipe strings or cement/resin sheaths, to seal highly permeable formation zones or fractures, to place a plug, and the like.

Resin-based materials may also be in the construction of wellbore tools, such as completion tools or casing equipment. Some examples of resin-based wellbore tools include mandrels, cement retainers, bridge plugs, and the like. The resin-based material may be molded or extruded to a desired shape and then incorporated into the tool or may comprise substantially the entirety of the wellbore tool itself. “Substantially the entirety,” as used herein, refers to a wellbore tool wherein greater than 95% of the wellbore tool comprises the resin-based material by weight.

Resin-based materials may experience a combination of shear, compressive, and tensile forces. The successful use of resin-based materials is important to successfully conduct wellbore operations. The present invention provides improved methods and compositions for preparing and using resin-based materials.

### BRIEF DESCRIPTION OF THE DRAWINGS

Illustrative examples of the present disclosure are described in detail below with reference to the attached drawing figures, which are incorporated by reference herein, and wherein:

FIG. 1 is a perspective drawing illustrating a boron nitride nanotube structure having hexagonal boron nitride structures epitaxial to the boron nitride nanotube in accordance with one or more examples described herein;

FIG. 2 is a perspective drawing illustrating pumping and mixing equipment for sealing with a resin-based material in accordance with one or more examples described herein;

FIG. 3 is a perspective drawing illustrating surface equipment for sealing with a resin-based material in accordance with one or more examples described herein;

FIG. 4 is a perspective drawing illustrating wellbore equipment for sealing with a resin-based material in accordance with one or more examples described herein;

FIG. 5 is a perspective drawing illustrating a wellbore tool in accordance with one or more examples described herein;

FIG. 6 is a perspective drawing illustrating another wellbore tool in accordance with one or more examples described herein;

FIG. 7 is a perspective drawing illustrating a top plug in accordance with one or more examples described herein;

FIG. 8 is a perspective drawing illustrating a bottom plug in accordance with one or more examples described herein; and

FIG. 9 is a perspective drawing illustrating a resin-based plug in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to using resin-based materials for sealing operations as well as for the construction of wellbore tools, and more particularly, to the inclusion of a boron nitride nanotube structure having hexagonal boron nitride structures epitaxial to the boron nitride nanotube to in a resin to improve the characteristics of the resin for sealing operations as well as for the construction of wellbore tools.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms uphole and downhole may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The examples described herein relate to the use of resin-based materials for sealing operations as well as for the construction of wellbore tools. In the examples described herein, a boron nitride nanotube structure having hexagonal boron nitride structures epitaxial to the boron nitride nanotube is dispersed within a resin to form a resin-based material. This inclusion of the boron nitride nanotube improves the characteristics of the resin for wellbore sealing and for the formation of wellbore tools. A “resin-based material,” as used herein, refers to any material in which a resin serves as the base of the material and all resin-based materials are derived from combining a resin with at least one other material. The resin-based material comprises a resin and a boron nitride nanotube structure. The boron nitride nanotube structure comprises a boron nitride nanotube with hexagonal boron nitride structures epitaxial to the boron nitride nanotube; this boron nitride nanotube structure is referred to herein as “BNNS”. The BNNS may be dispersed within the resin to form the resin-based material. The inclusion of the BNNS within the resin may improve the material characteristics of the resin. For example, the addition of the BNNS to the resin may result in improvements to tensile strength, stress at yield, and Young's modulus. The resin-based material may possess improved performance in sealing operations such as primary cementing and remedial cementing. For example, the resin-based materials may possess superior temperature resistance than traditional resins. The resin-based material may perform better in aggressive environments than traditional resins. The resin-based material may also improve the performance of wellbore tools comprising the resin-based material such as bridge plugs, retainers, and tools containing mandrels or other components made of resin. Another advantage of these resin-based materials is that the BNNS is easier to disperse within the resin than boron nanotubes or other species of nanotubes. The BNNS structure may limit contact between the individual BNNS nanotubes, thereby reducing the influence of Van der Walls forces while also increasing the area of interaction within the resin matrix in order to improve dispersion and the bulk mechanical properties. In addition to cement or elastomeric materials, the resin-based material may also be used to replace other wellbore materials such as fiberglass. Fiberglass is an anisotropic material, and the measurable strength and stiffness of fiberglass is in line with the direction of the fiber weave. The resin-based material is isotropic and possesses the same strength in all directions. Advantageously, the resin-based material may be used to replace fiberglass in any wellbore tool containing fiberglass.

The resin-based material comprises the BNNS. Boron nitride nanotubes are nano-scale hollow tubes. The BNNS is a structure that comprises a boron nitride nanotube and at least one hexagonal boron nitride structure. The hexagonal boron nitride structure(s) is/are epitaxial with respect to the boron nitride nanotube. Accordingly, each BNNS includes a boron nitride nanotube and at least one hexagonal boron nitride structure epitaxial to the boron nitride nanotube.

The boron nitride nanotubes may have diameters in the range of from about 3 to about nanometers, and lengths in the range of about 10 nanometers to about 50 microns. The boron nitride nanotubes may have a structure consisting of a single tubular layer (e.g., single-wall boron nitride nanotubes), as well as a structure consisting of multiple tubular layers which are each generally coaxial (e.g., multi-wall boron nitride nanotubes). The boron nitride nanotubes may comprise one or more layers (i.e., walls), with each layer consisting of a generally tubular arrangement of boron atoms and nitrogen atoms. The boron atoms and nitrogen atoms may be arranged in a repeating hexagonal pattern in which boron atoms and nitrogen atoms alternate.

Epitaxy is the process of nucleating a crystal of a well-defined particular orientation with respect to the seed crystal. For each hexagonal boron nitride structure, the atoms in the hexagonal boron nitride structure, and the atoms in the boron nitride nanotube structure that are closest to the hexagonal boron nitride structure, are arranged in the manner that results from nucleating a hexagonal boron nitride on the boron nitride nanotube structure and growing the hexagonal boron nitride structure on the nucleated hexagonal boron nitride. Epitaxial refers to this hexagonal boron nitride structure grown from the arranged hexagonal boron nitride that was deposited on the boron nitride nanotube.

The hexagonal boron nitride structure comprises a stacking of two-dimensional honeycomb lattices made of boron and nitrogen atoms that are strongly bound by highly polar B—N bonds. The layers of the hexagonal boron nitride may generally stack in an AA′ stacking mode, i.e., a boron atom bearing a partial positive charge in one layer resides on the oppositely charged nitrogen atoms on the adjacent layers. Nodules of hexagonal boron nitride that are epitaxial with and covering the boron nitride nanotube structure are approximately 1 nm to 200 nm thick.

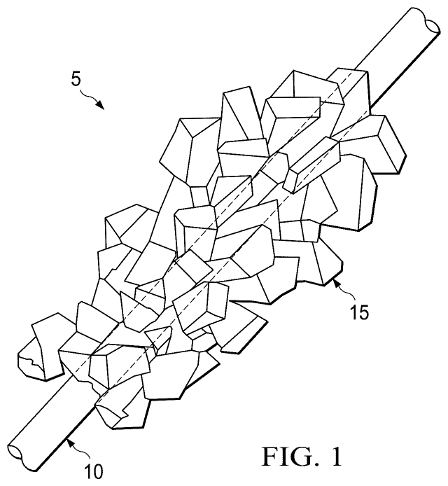

FIG. 1 is an example perspective drawing illustrating an example BNNS, generally 5. In the examples of FIG. 1, the boron nitride nanotube 10 serves as the seed structure from which a hexagonal boron nitride may be nucleated. The hexagonal boron nitride structure 15 may then be grown from the nucleated hexagonal boron nitride. The BNNS may be produced with a plasma generator such as an inductively coupled plasma generator or a DC arc plasma generator.

The concentration of the BNNS in the resin-based material may range from about 0.1% to about 10% by weight of the resin-based material. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the BNNS in the resin-based material may range, from about 0.1% to about 10% by weight of the resin-based material, from about 0.5% to about 10% by weight of the resin-based material, from about 1% to about 10% by weight of the resin-based material, from about 3% to about 10% by weight of the resin-based material, from about 5% to about 10% by weight of the resin-based material, or from about 8% to about 10% by weight of the resin-based material. As another example, the concentration of the BNNS in the resin-based material may range from about 0.1% to about 10% by weight of the resin-based material, from about 0.1% to about 8% by weight of the resin-based material, from about 0.1% to about 5% by weight of the resin-based material, from about 0.1% to about 3% by weight of the resin-based material, from about 0.1% to about 1% by weight of the resin-based material, or from about 0.1% to about 0.5% by weight of the resin-based material. With the benefit of this disclosure, one of ordinary skill in the art will be readily able to prepare a resin-based material having a sufficient concentration of the BNNS for a given application.

The BNNS is combined with a resin to form the resin-based material. Examples of the resin include, but are not limited to, shellac, a polyamide, a silyl-modified polyamide, a polyester, a polycarbonate, a polycarbamate, a urethane, a polyurethane, a natural resin, an olefin resin, an epoxy-based resin (e.g., epoxy-amine or epoxy-anhydride), a furan-based resin, a phenolic-based resin, a urea-aldehyde resin, a phenol-phenol formaldehyde-furfuryl alcohol resin, a bisphenol A diglycidyl ether resin, a butoxymethyl butyl glycidyl ether resin, a bisphenol A-epichlorohydrin resin, a bisphenol F resin, a bisphenol S resin, a diglycidyl ether of bisphenol F epoxy resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, any derivative thereof, or combinations thereof. With the benefit of this disclosure, one of ordinary skill in the art will be readily able to select a suitable resin for use with the resin-based material.

The concentration of the resin in the resin-based material may range from about 0.5% (w/v) to about 99% (w/v). The concentration of the resin in the resin-based material may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the resin in the resin-based material may range from about 0.5% (w/v) to about 99% (w/v), from about 1% (w/v) to about 99% (w/v), from about 5% (w/v) to about 99% (w/v), from about 10% (w/v) to about 99% (w/v), from about 15% (w/v) to about 99% (w/v), from about 20% (w/v) to about 99% (w/v), from about 25% (w/v) to about 99% (w/v), from about 30% (w/v) to about 99% (w/v), from about 35% (w/v) to about 99% (w/v), from about 40% (w/v) to about 99% (w/v), from about 45% (w/v) to about 99% (w/v), from about 50% (w/v) to about 99% (w/v), from about 55% (w/v) to about 99% (w/v), from about 60% (w/v) to about 99% (w/v), from about 65% (w/v) to about 99% (w/v), from about 70% (w/v) to about 99% (w/v), from about 75% (w/v) to about 99% (w/v), from about 80% (w/v) to about 99% (w/v), from about 85% (w/v) to about 99% (w/v), from about 90% (w/v) to about 99% (w/v), or from about 95% (w/v) to about 99% (w/v). As another example, the concentration of the resin in the resin-based material may range from about 0.5% (w/v) to about 99% (w/v), from about 0.5% (w/v) to about 95% (w/v), from about 0.5% (w/v) to about 90% (w/v), from about 0.5% (w/v) to about 85% (w/v), from about 0.5% (w/v) to about 80% (w/v), from about 0.5% (w/v) to about 75% (w/v), from about 0.5% (w/v) to about 70% (w/v), from about 0.5% (w/v) to about 65% (w/v), from about 0.5% (w/v) to about 60% (w/v), from about 0.5% (w/v) to about 55% (w/v), from about 0.5% (w/v) to about 50% (w/v), from about 0.5% (w/v) to about 45% (w/v), from about 0.5% (w/v) to about 40% (w/v), from about 0.5% (w/v) to about 35% (w/v), from about 0.5% (w/v) to about 30% (w/v), from about 0.5% (w/v) to about 25% (w/v), from about 0.5% (w/v) to about 20% (w/v), from about 0.5% (w/v) to about 15% (w/v), from about 0.5% (w/v) to about 10% (w/v), from about 0.5% (w/v) to about 5% (w/v), or from about 0.5% (w/v) to about 1% (w/v). With the benefit of this disclosure, one of ordinary skill in the art will be able to prepare a resin-based material having a sufficient concentration of resin for a given application.

Optionally, in some examples, a hardening agent may be added to the resin-based material. The hardening agent may be any hardening agent sufficient for curing the selected resin. Examples of the hardening agent include, but are not limited to, diethylenetoluene diamine, cyclo-aliphatic amines, piperazine, derivatives of piperazine (e.g., aminoethylpiperazine), modified piperazines, aromatic amines, methylene dianiline, hydrogenated forms of dianiline, 4,4′-diaminodiphenyl sulfone, 2H-pyrrole, pyrrole, imidazole, pyrazole, pyridine, pyrazine, pyrimidine, pyridazine, indolizine, isoindole, 3H-indole, indole, 1H-indazole, purine, 4H-quinolizine, quinoline, isoquinoline, phthalazine, naphthyridine, quinoxaline, quinazoline, 4H-carbazole, carbazole, O-carboline, phenanthridine, acridine, phenathroline, phenazine, imidazolidine, phenoxazine, cinnoline, pyrrolidine, pyrroline, imidazoline, piperidine, indoline, isoindoline, quinuclindine, morpholine, azocine, azepine, 2H-azepine, 1,3,5-triazine, thiazole, pteridine, dihydroquinoline, hexamethylene imine, indazole, amines, aromatic amines, polyamines, aliphatic amines, ethylene diamine, diethylene triamine, triethylene tetraamine, tetraethylene pentaamine, cyclo-aliphatic amines, amides, polyamides, 2-ethyl-4-methyl imidazole, 1,1,3-trichlorotrifluoroacetone, any derivatives thereof, transition metal carbene complexes, or combinations thereof. With the benefit of this disclosure, one of ordinary skill in the art will be readily able to select a suitable hardening agent for use with the resin-based material.

The concentration of the hardening agent in the resin-based material may range from about 10% to about 150% by weight of the resin. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the hardening agent in the resin-based material may range, from about 10% to about 150% by weight of the resin, from about 20% to about 150% by weight of the resin, from about 30% to about 150% by weight of the resin, from about 40% to about 150% by weight of the resin, from about 50% to about 150% by weight of the resin, from about 60% to about 150% by weight of the resin, from about 70% to about 150% by weight of the resin, from about 80% to about 150% by weight of the resin, from about 90% to about 150% by weight of the resin, from about 100% to about 150% by weight of the resin, from about 110% to about 150% by weight of the resin, from about 120% to about 150% by weight of the resin, from about 130% to about 150% by weight of the resin, or from about 140% to about 150% by weight of the resin. As another example, the concentration of the hardening agent in the resin-based material may range from about 10% to about 150% by weight of the resin, from about 10% to about 140% by weight of the resin, from about 10% to about 130% by weight of the resin, from about 10% to about 120% by weight of the resin, from about 10% to about 110% by weight of the resin, from about 10% to about 100% by weight of the resin, from about 10% to about 90% by weight of the resin, from about 10% to about 80% by weight of the resin, from about 10% to about 70% by weight of the resin, from about 10% to about 60% by weight of the resin, from about 10% to about 50% by weight of the resin, from about 10% to about 40% by weight of the resin, from about 10% to about 30% by weight of the resin, or from about 10% to about 20% by weight of the resin. With the benefit of this disclosure, one of ordinary skill in the art will be readily able to prepare a resin-based material having a sufficient concentration of hardening agent for a given application.

Optionally, in some examples, the resin-based material may include an accelerator to control the setting time of the resin-based material. Examples of the accelerator include, but are not limited to, 2,4,6-tris(dimethylaminomethyl)phenol, benzyl dimethylamine, 1,4-diazabicyclo[2.2.2]octane), 2-ethyl,-4-methylimidazole, 2-methylimidazole, 1-(2-cyanoethyl)-2-ethyl-4-methylimidazole), aluminum chloride, boron trifluoride, boron trifluoride ether complexes, boron trifluoride alcohol complexes, boron trifluoride amine complexes, any derivatives thereof, or any combinations thereof. With the benefit of this disclosure, one of ordinary skill in the art will be readily able to select a suitable accelerator for use with the resin-based material.

The concentration of the accelerator in the resin-based material may range from about 0.1% to about 10% by weight of the resin-based material. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the accelerator in the resin-based material may range, from about 0.1% to about 10% by weight of the resin-based material, from about 0.5% to about 10% by weight of the resin-based material, from about 1% to about 10% by weight of the resin-based material, from about 3% to about 10% by weight of the resin-based material, from about 5% to about 10% by weight of the resin-based material, or from about 8% to about 10% by weight of the resin-based material. As another example, the concentration of the accelerator in the resin-based material may range from about 0.1% to about 10% by weight of the resin-based material, from about 0.1% to about 8% by weight of the resin-based material, from about 0.1% to about 5% by weight of the resin-based material, from about 0.1% to about 3% by weight of the resin-based material, from about 0.1% to about 1% by weight of the resin-based material, or from about 0.1% to about 0.5% by weight of the resin-based material. With the benefit of this disclosure, one of ordinary skill in the art will be readily able to prepare a resin-based material having a sufficient concentration of accelerator for a given application.

Optionally, in some examples, a solvent may be added to the resin-based material to adjust the viscosity of the resin-based material. Any solvent that is compatible with the resin-based material is suitable for use in the resin-based material. Examples of solvents include, but are not limited to, mineral oil, butyl lactate, butylglycidyl ether, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, methanol, butyl alcohol, d'limonene, fatty acid methyl esters, methanol, isopropanol, butanol, glycol ether solvents, diethylene glycol methyl ether, dipropylene glycol methyl ether, 2-butoxy ethanol, ethers of a C2 to C6 dihydric alkanol containing at least one C1 to C6 alkyl group, mono ethers of dihydric alkanols, methoxypropanol, butoxyethanol, hexoxyethanol, isomers or derivatives thereof, or any combination. With the benefit of this disclosure, one of ordinary skill in the art will be readily able to select a suitable solvent for use with the resin-based material.

The concentration of the solvent in the resin-based material may range from about 0.5% (w/v) to about 85% (w/v). The concentration of the cement in the cement composition may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the solvent in the resin-based material may range from about 0.5% (w/v) to about 85% (w/v), from about 1% (w/v) to about 85% (w/v), from about 5% (w/v) to about 85% (w/v), from about 10% (w/v) to about 85% (w/v), from about 15% (w/v) to about 85% (w/v), from about 20% (w/v) to about 85% (w/v), from about 25% (w/v) to about 85% (w/v), from about 30% (w/v) to about 85% (w/v), from about 35% (w/v) to about 85% (w/v), from about 40% (w/v) to about 85% (w/v), from about 45% (w/v) to about 85% (w/v), from about 50% (w/v) to about 85% (w/v), from about 55% (w/v) to about 85% (w/v), from about 60% (w/v) to about 85% (w/v), from about 65% (w/v) to about 85% (w/v), from about 70% (w/v) to about 85% (w/v), from about 75% (w/v) to about 85% (w/v), or from about 80% (w/v) to about 85% (w/v). As another example, the concentration of the solvent in the resin-based material may range from about 0.5% (w/v) to about 85% (w/v), from about 0.5% (w/v) to about 80% (w/v), from about 0.5% (w/v) to about 75% (w/v), from about 0.5% (w/v) to about 70% (w/v), from about 0.5% (w/v) to about 65% (w/v), from about 0.5% (w/v) to about 60% (w/v), from about 0.5% (w/v) to about 55% (w/v), from about 0.5% (w/v) to about 50% (w/v), from about 0.5% (w/v) to about 45% (w/v), from about 0.5% (w/v) to about 40% (w/v), from about 0.5% (w/v) to about 35% (w/v), from about 0.5% (w/v) to about 30% (w/v), from about 0.5% (w/v) to about 25% (w/v), from about 0.5% (w/v) to about 20% (w/v), from about 0.5% (w/v) to about 15% (w/v), from about 0.5% (w/v) to about 10% (w/v), from about 0.5% (w/v) to about 5% (w/v), or from about 0.5% (w/v) to about 1% (w/v). With the benefit of this disclosure, one of ordinary skill in the art will be able to prepare a resin-based material having a sufficient concentration of solvent for a given application.

The components of the resin-based material may be combined in any order desired to form a resin-based material that can be placed into a subterranean formation or formed into a wellbore tool. In addition, the components of the resin-based material may be combined using any mixing device compatible with the composition. In some examples, an ultrasonic probe sonicator may be used to disperse the BNNS within the resin. If a sonicator is used, sonication may continue until no particulate settling is observed. With the benefit of this disclosure, other suitable techniques may be used for the preparation of the resin-based material as will be appreciated by those of ordinary skill in the art in accordance with the disclosed examples.

The resin-based material generally has a density suitable for a particular application. By way of example, the resin-based material may have a density in the range of from about 4 pounds per gallon (“lb/gal”) to about 20 lb/gal. In certain examples, the resin-based material may have a density in the range of from about 8 lb/gal to about 17 lb/gal. Examples of the resin-based material may comprise additives to reduce their densities, such as hollow microspheres, low-density elastic beads, or other density-reducing additives known in the art. In some examples, the density may be reduced after storing the resin-based material, but prior to use. Those of ordinary skill in the art, with the benefit of this disclosure, will recognize the appropriate density of the resin-based material for a particular application.

Examples of the resin-based material may be used in a variety of sealant operations such as a replacement for or as a supplement to cement in subterranean cementing operations (e.g., primary and remedial cementing). The resin-based material may be introduced into a subterranean formation and allowed to cure therein. As used herein, introducing the resin-based material into a subterranean formation includes introduction into any portion of the subterranean formation, including, without limitation, into a wellbore drilled into the subterranean formation, into a near wellbore region surrounding the wellbore, or into both.

In some example primary cementing methods, the resin-based material may be introduced into an annular space between a conduit located in a wellbore and the walls of a wellbore (and/or a larger conduit in the wellbore). The resin-based material may be allowed to cure in the annular space to form an annular sheath of cured resin. The cured resin may form a barrier that prevents the migration of fluids in the wellbore. The cured resin may also support a conduit in the wellbore.

In some example remedial cementing methods, a resin-based material may be used as a replacement for or as a supplement to cement in squeeze-cementing operations or in the placement of plugs. By way of example, the resin-based material may be placed in a wellbore to plug an opening (e.g., a void or crack) in the formation, in a gravel pack, in a conduit, in a resin/cement sheath, or in between the resin/cement sheath and the conduit (e.g., in a microannulus).

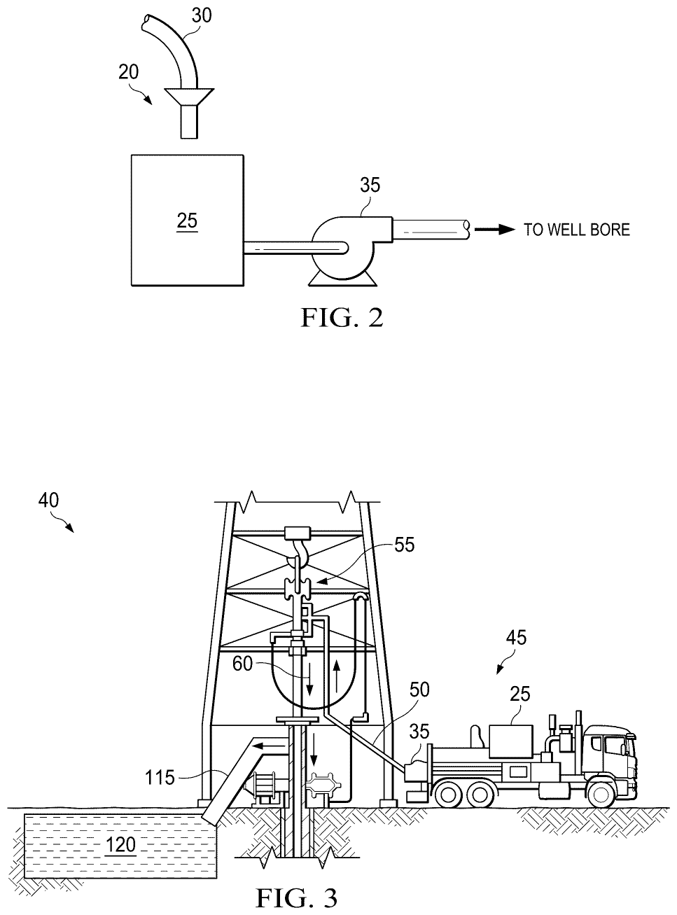

Referring now to FIG. 2, the preparation of a resin-based material will now be described. FIG. 2 is an illustration of a system 20 for the preparation of a resin-based material and delivery to a wellbore in accordance with certain examples. As shown, the resin and BNNS may be combined and mixed in a vessel 25. An ultrasonic probe sonicator 30 may be introduced to the vessel 25 and used to disperse the BNNS within the resin to form the resin-based material. Additional additives may be added into vessel 25 and combined with the resin-based material as desired. In some examples, vessel 25 may comprise the mixing equipment itself, for example, a jet mixer, re-circulating mixer, or a batch mixer. Should vessel 25 comprise mixing equipment, the ultrasonic probe sonicator 30 may be used before or after mixing the components of the resin-based material with the mixing equipment. In some examples, the ultrasonic probe sonicator may be used to disperse the BNNS into the resin in a separate vessel and then the resin-based material may be added to vessel 25 to be further mixed with the mixing equipment of vessel 25 if present.

After the resin-based material has been prepared it may be pumped via pumping equipment 35 to the wellbore. In some examples, the vessel 25 and the pumping equipment 35 may be disposed on one or more mixing/pumping trucks as will be apparent to those of ordinary skill in the art. In some examples, a jet mixer may be used to continuously mix the resin-based material as it is being pumped to the wellbore.

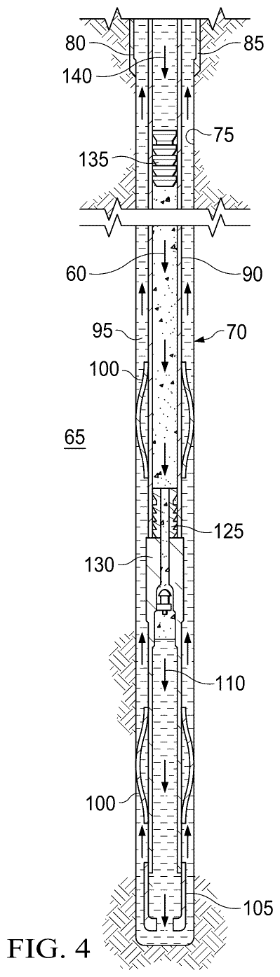

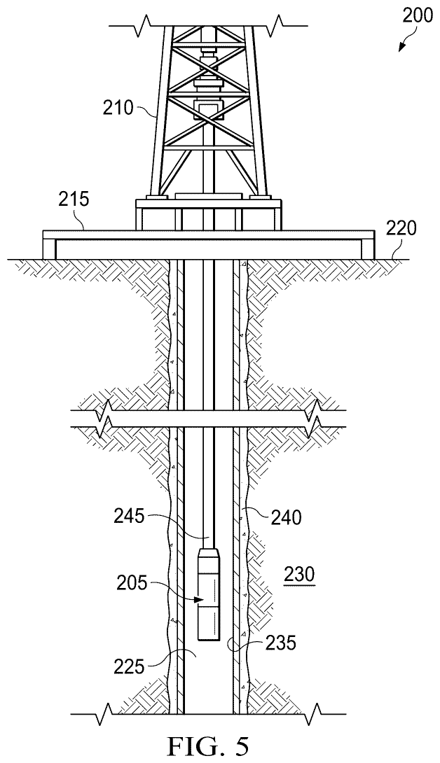

With reference to FIGS. 3 and 4, an example technique for placing the resin-based material into a subterranean formation will now be described. FIG. 3 illustrates surface equipment 40 that may be used in the placement of a resin-based material in accordance with certain examples. It should be noted that while FIG. 3 generally depicts a land-based operation, those skilled in the art will readily recognize that the principles described herein are equally applicable to subsea operations that employ floating or sea-based platforms and rigs, without departing from the scope of the disclosure. As illustrated by FIG. 3, the surface equipment 40 may include a resin supply unit 45, which may include one or more trucks. The resin supply unit 45 may include vessel 25 and pumping equipment 35 as illustrated in FIG. 2. The resin supply unit 45 may pump the resin-based material through a feed pipe 50 and to a cementing head 55 which conveys the resin-based material 60 downhole.

Turning now to FIG. 4, the resin-based material 60 may be placed into a subterranean formation 65 in accordance with the examples discussed herein. As illustrated, a wellbore 70 may be drilled into the subterranean formation 65. While wellbore 70 is shown extending generally vertically into the subterranean formation 65, the principles described herein are also applicable to wellbores that extend at an angle through the subterranean formation 65, such as horizontal and slanted wellbores. As illustrated, the wellbore 65 comprises walls 75. In the illustrated embodiment, a surface casing 80 has been inserted into the wellbore 70. The surface casing 80 may be fixed to the walls 75 of the wellbore 70 by a cured resin sheath 85. In the illustrated example, one or more additional conduits (e.g., intermediate casing, production casing, liners, etc.), shown here as casing 90, may also be disposed in the wellbore 70. As illustrated, there is a wellbore annulus 95 formed between the casing 90 and the walls 75 of the wellbore 70 and/or the surface casing 80. One or more centralizers 100 may be attached to the casing 90, for example, to centralize the casing 90 in the wellbore 70 prior to and during the sealing operation.

With continued reference to FIG. 4, the resin-based material 60 may be pumped down the interior of the casing 90. The resin-based material 60 may be allowed to flow down the interior of the casing 90 through the casing shoe 105 at the bottom of the casing 90 and up around the casing 90 into the wellbore annulus 95. The resin-based material 60 may be allowed to set in the wellbore annulus 95, for example, to form a cured resin sheath that supports and positions the casing 90 in the wellbore 70. While not illustrated, other techniques may also be utilized for the introduction of the resin-based material 60. By way of example, reverse circulation techniques may be used that include introducing the resin-based material 60 into the subterranean formation 65 by way of the wellbore annulus 95 instead of through the casing 90.

As it is introduced, the resin-based material 60 may displace other fluids 110, such as drilling fluids and/or spacer fluids that may be present in the interior of the casing 90 and/or the wellbore annulus 95. At least a portion of the displaced fluids 110 may exit the wellbore annulus 95 via a flow line 115 and may then be deposited, for example, in one or more retention pits 120 (e.g., a mud pit), as shown on FIG. 3. Referring again to FIG. 4, a bottom plug 125 may be introduced into the wellbore 70 ahead of the resin-based material 60 to separate the resin-based material 60 from the other fluids 110 that may be inside the casing 90 prior to introducing the resin-based material 60. After the bottom plug 125 reaches the landing collar 130, a diaphragm or other suitable device should rupture to allow the resin-based material 60 through the bottom plug 125. In FIG. 4, the bottom plug 125 is shown on the landing collar 130. In the illustrated example, a top plug 135 may be introduced into the wellbore 70 behind the resin-based material 60. The top plug 135 may separate the resin-based material 60 from a displacement fluid 140 and also push the resin-based material 60 through the bottom plug 125.

The exemplary resin-based material disclosed herein may directly or indirectly affect one or more components or pieces of equipment associated with the preparation, delivery, recapture, recycling, reuse, and/or disposal of the disclosed resin-based material. For example, the disclosed resin-based material may directly or indirectly affect one or more mixers, related mixing equipment, mud pits, storage facilities or units, composition separators, heat exchangers, sensors, gauges, pumps, compressors, and the like used to generate, store, monitor, regulate, and/or recondition the exemplary cement compositions. The disclosed resin-based material may also directly or indirectly affect any transport or delivery equipment used to convey the resin-based material to a well site or downhole such as, for example, any transport vessels, conduits, pipelines, trucks, tubulars, and/or pipes used to compositionally move the resin-based material from one location to another, any pumps, compressors, or motors (e.g., topside or downhole) used to drive the resin-based material into motion, any valves or related joints used to regulate the pressure or flow rate of the resin-based material, and any sensors (i.e., pressure and temperature), gauges, and/or combinations thereof, and the like. The disclosed resin-based material may also directly or indirectly affect the various downhole equipment and tools that may come into contact with the resin-based material such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

It should be clearly understood that the example system illustrated by FIGS. 2-4 are merely a general application of the principles of this disclosure in practice, and a wide variety of other examples are possible. Therefore, the scope of this disclosure is not limited in any manner to the details of FIGS. 2-4 as described herein.

Referring now to FIG. 5, an example well system 200 for a downhole tool 205 is illustrated. A derrick 210 with a rig floor 215 is positioned on the surface 220 of a wellsite above a wellbore 225 that extends into a subterranean formation 230. As shown, the wellbore 225 is lined with a casing 235 that is fixed into place with a hardened sheath 240 formed from a resin-based material or a cement. It will be appreciated that although FIG. 5 depicts the wellbore 225 encased with a casing 235, the wellbore 225 may be wholly or partially cased and/or wholly or partially covered with a hardened sheath 240, without departing from the scope of the present disclosure. In some examples, the wellbore 225 may be an open-hole wellbore. A tool string 245 extends from the derrick 210 and the rig floor 215 into the wellbore 225. The tool string 245 may be any mechanical connection to the surface, such as a wireline, slickline, jointed pipe, coiled tubing, etc. The tool string 245 suspends the downhole tool 205 for placement into the wellbore 225 at a desired location to perform a specific downhole operation. The downhole tool 205 may be a wellbore isolation device, a frac plug, a bridge plug, a packer, a wiper plug, a cement plug, a perforating gun, a well screen tool, a drilling tool, and the like, and any combination thereof.

The downhole tool 205 may be made from substantially the entirely of the resin-based material. Alternatively, one or more components of the downhole tool 205 may be made of the resin-based material. Examples of components which may be made from the resin-based material include, but are not limited to, mandrels, sealing elements, spacer rings, slips, wedges, retainer rings, extrusion limiters, backup shoes, mule shoes, tapered shoes, flappers, balls, ball seats, O-rings, sleeves, screens, wipers, enclosures, darts, valves, latches, actuators, actuation control devices, or any combination.

The downhole tool 205 or a component thereof may comprise the resin-based material. The resin-based material may be prepared as described above by combining a resin and the BNNS (and any optional additives) and dispersing the BNNS in the resin using any suitable method such as sonication. The resin-based material may then be injected into a mold to form the downhole tool 205 or a thereof. Alternatively, the resin-based material may be extruded to form the downhole tool 205 or a component thereof. As another alternative, the resin-based material may be rolled to form the downhole tool 205 or a component thereof. An additional processing method is to forge the resin-based material to form the downhole tool 205 or a component thereof. One other processing method is to stamp the resin-based material to form the downhole tool 205 or a component thereof. Generally, any method that heats, shapes, and solidifies the resin-based material will be sufficient for forming the downhole tool 205 or a component thereof.

It should be clearly understood that the example system illustrated by FIG. 5 is merely a general application of the principles of this disclosure in practice, and a wide variety of other examples are possible. Therefore, the scope of this disclosure is not limited in any manner to the details of FIG. 5 as described herein.

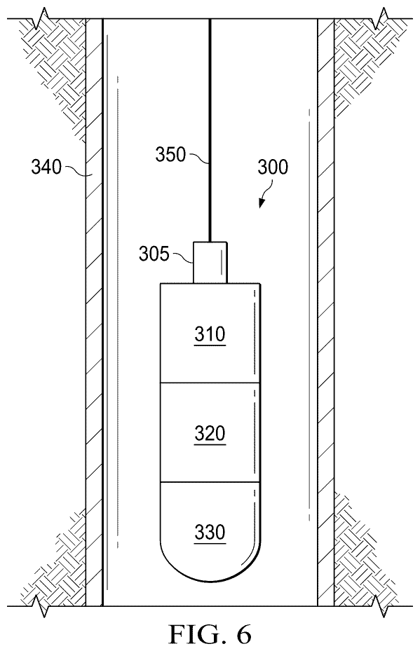

FIG. 6 illustrates a perspective drawing of a downhole tool 300. Downhole tool 300 comprises a mandrel 305, component 310, component 320, and component 330. In the illustrated example, the mandrel 305 comprises a resin-based material. Component 310, component 320, and/or component 330 may also comprise a resin-based material. Alternatively, component 310, component 320, and/or component 330 may not comprise a resin-based material. Component 310, component 320, and/or component 330 may comprise a wellbore tool component including, but not limited to, a sealing element, a spacer ring, a slip, a wedge, a retainer ring, an extrusion limiter, an O-ring, a sleeve, an enclosure, a valve, a latch, an actuator, an actuation control device, a screen, a wiper, and such wellbore tool component as would be apparent to one of ordinary skill in the art. Downhole tool 300 is introduced into a wellbore 340 via a conveyance 350. The conveyance 350 may be a wireline, slickline, jointed pipe, coiled tubing, etc. When downhole tool 300 has reached a desired location within wellbore 340, downhole tool 300 may be used to perform a wellbore operation as desired.

It should be clearly understood that the example tool illustrated by FIG. 6 is merely a general application of the principles of this disclosure in practice, and a wide variety of other examples are possible. Therefore, the scope of this disclosure is not limited in any manner to the details of FIG. 6 as described herein.

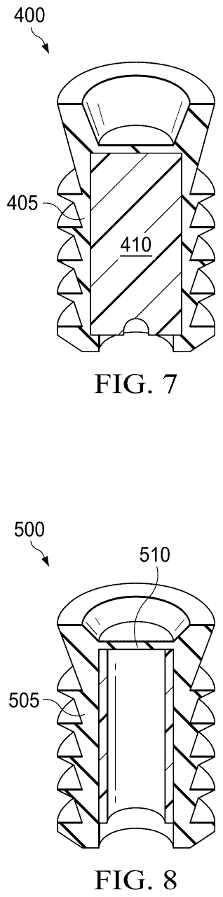

FIG. 7 illustrates a top plug 400 used for cementing operations. The top plug 400 comprises a body 405 and a solid core 410. The body 405 and/or the solid core 410 may comprise a resin-based material as described herein.

FIG. 8 illustrates a bottom plug 500 used for cementing operations. The bottom plug 500 comprises a body 505 and a rupture disk 510. The body 505 may comprise a resin-based material as described herein.

It should be clearly understood that the example plugs illustrated by FIGS. 7 and 8 are merely a general application of the principles of this disclosure in practice, and a wide variety of other examples are possible. Therefore, the scope of this disclosure is not limited in any manner to the details of FIGS. 7 and 8 as described herein.

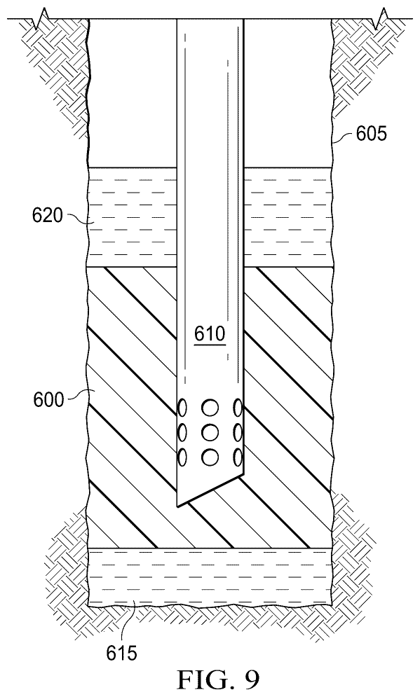

FIG. 9 illustrates a cured resin plug 600 for a plugging operation. Resin plug 600 comprises a cured resin-based material. The resin-based material is introduced into wellbore 605 via tubing 610 where it is allowed to cure. Additional non-resin-based fluids 615 and 620 may be introduced before or after the introduction of the resin-based material.

It should be clearly understood that the example plugging operation illustrated by FIG. 9 is merely a general application of the principles of this disclosure in practice, and a wide variety of other examples are possible. Therefore, the scope of this disclosure is not limited in any manner to the details of FIG. 9 as described herein.

### EXAMPLES

The present disclosure may be better understood by reference to the following examples, which are offered by way of illustration. The present disclosure is not limited to the examples provided herein.

### Example 1

Example 1 is an example experiment to measure the properties of a cured resin-based material comprising the BNNS. In order to prepare the resin-based material, 5.3 grams of BNNS powder was combined with 186.3 grams of digylcidyl ether of bisphenol F epoxy resin (DGEBF) liquid. The BNNS was dispersed in the DGEBF using an ultrasonic probe sonicator. The BNNS/DGEBF composition was sonicated for three 5-minute intervals. Each sonication interval required 23 kJ of energy. The BNNS/DGEBF resin-based material was allowed to cool to room temperature prior to commencing the next sonication interval. When no visual observation of particulate settling was observed, 72.1 grams of diethyltoluene diamine hardener and 7.4 grams of 2,4,6 tridimethylaminomethyl phenol accelerator were added to the resin-based material. The resin-based material was shaken and then allowed to cure under ambient laboratory conditions for 7 days. A control sample containing the same resin, hardener, and accelerator ratios without the BNNS was prepared and cured in parallel under laboratory conditions for 7 days.

Cylindrical samples were tested in compression to measure the stress versus strain behavior and tensile strength. Compressive displacement was controlled at ⅛ inch per minute. If the displacement reaches 40 percent compressive strain without sample failure, the test is stopped. For comparative purposes the stress at yield is measured as opposed to compressive strength in resin samples. The addition of 1 percent of the BNNS using the described sonication dispersion technique resulted in a composite sample with a 5 percent increase in stress at yield, a 6 percent increase in Young's modulus, and a 174 percent increase in tensile strength.

It is also to be recognized that the disclosed resin-based materials may also directly or indirectly affect the various downhole equipment and tools that may contact the resin-based materials disclosed herein. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the methods and systems generally described above and depicted in FIGS. 2-9.

Provided are methods for performing a wellbore operation in a subterranean formation in accordance with the disclosure and the illustrated FIGs. An example method comprises introducing a resin-based material into a wellbore, the resin-based material comprising a resin and a boron nitride nanotube structure comprising a boron nitride nanotube having a hexagonal boron nitride structure epitaxial to the boron nitride nanotube. The method further comprises performing the wellbore operation in the wellbore with the resin-based material.

Additionally or alternatively, the method may include one or more of the following features individually or in combination. The wellbore operation may be a sealant operation. The sealant operation may be a cementing operation and the resin-based material is used in place of or in addition to the cement. The wellbore operation may be performed with a wellbore tool and wherein the wellbore tool comprises the resin-based material. The resin-based material may comprise substantially the entirety of the wellbore tool. The resin-based material may comprise a component of the wellbore tool. The boron nitride nanotube structure may be dispersed in the resin with sonication. The resin-based material may be a sealant used in a sealing operation in a wellbore. The resin-based material may form a component of a wellbore tool. The component may be any species of mandrel, sealing element, spacer ring, slip, wedge, retainer ring, extrusion limiter, backup shoe, mule shoe, tapered shoe, flapper, ball, ball seat, O-ring, sleeve, screen, wiper, enclosure, dart, valve, latch, actuator, actuation control device, or any combination. The resin-based material may form substantially the entirety of a wellbore tool. The wellbore tool may be any species of wellbore isolation device, frac plug, bridge plug, packer, wiper plug, cement plug, perforating gun, well screen tool, drilling tool, or any combination thereof. The resin may comprise a resin selected from the group consisting of shellac, a polyamide, a silyl-modified polyamide, a polyester, a polycarbonate, a polycarbamate, a urethane, a polyurethane, a natural resin, an olefin resin, an epoxy-based resin (e.g., epoxy-amine or epoxy-anhydride), a furan-based resin, a phenolic-based resin, a urea-aldehyde resin, a phenol-phenol formaldehyde-furfuryl alcohol resin, bisphenol A diglycidyl ether resin, butoxymethyl butyl glycidyl ether resin, bisphenol A-epichlorohydrin resin, bisphenol F resin, bisphenol S resin, diglycidyl ether of bisphenol F epoxy resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, or any combination thereof. The resin-based material may further comprise a hardening agent. The resin-based material may further comprise an accelerator.

Provided are compositions for resin-based materials in accordance with the disclosure and the illustrated FIGs. An example resin-based material composition comprises a resin and a boron nitride nanotube structure comprising a boron nitride nanotube having a hexagonal boron nitride structure epitaxial to the boron nitride nanotube.

Additionally or alternatively, the composition may include one or more of the following features individually or in combination. The boron nitride nanotube structure may be dispersed in the resin with sonication. The resin-based material may be a sealant used in a sealing operation in a wellbore. The resin-based material may form a component of a wellbore tool. The component may be any species of mandrel, sealing element, spacer ring, slip, wedge, retainer ring, extrusion limiter, backup shoe, mule shoe, tapered shoe, flapper, ball, ball seat, O-ring, sleeve, screen, wiper, enclosure, dart, valve, latch, actuator, actuation control device, or any combination. The resin-based material may form substantially the entirety of a wellbore tool. The wellbore tool may be any species of wellbore isolation device, frac plug, bridge plug, packer, wiper plug, cement plug, perforating gun, well screen tool, drilling tool, or any combination thereof. The resin may comprise a resin selected from the group consisting of shellac, a polyamide, a silyl-modified polyamide, a polyester, a polycarbonate, a polycarbamate, a urethane, a polyurethane, a natural resin, an olefin resin, an epoxy-based resin (e.g., epoxy-amine or epoxy-anhydride), a furan-based resin, a phenolic-based resin, a urea-aldehyde resin, a phenol-phenol formaldehyde-furfuryl alcohol resin, bisphenol A diglycidyl ether resin, butoxymethyl butyl glycidyl ether resin, bisphenol A-epichlorohydrin resin, bisphenol F resin, bisphenol S resin, diglycidyl ether of bisphenol F epoxy resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, or any combination thereof. The resin-based material may further comprise a hardening agent. The resin-based material may further comprise an accelerator.

Provided are systems for performing a wellbore operation in a subterranean formation in accordance with the disclosure and the illustrated FIGs. An example system comprises a resin-based material comprising a resin and a boron nitride nanotube structure comprising a boron nitride nanotube having a hexagonal boron nitride structure epitaxial to the boron nitride nanotube. The system further comprises a conveyance to introduce the resin-based material into a wellbore.

Additionally or alternatively, the system may include one or more of the following features individually or in combination. The resin-based material may be a sealant, and the conveyance is a pump configured to pump the resin-based material into the wellbore. The resin-based material may form at least a part of a wellbore tool and the conveyance is a wireline configured to transport the wellbore tool into the wellbore. The system may further comprise an ultrasonic sonicator configured to disperse the boron nitride nanotube structure in the resin. The boron nitride nanotube structure may be dispersed in the resin with sonication. The resin-based material may be a sealant used in a sealing operation in a wellbore. The resin-based material may form a component of a wellbore tool. The component may be any species of mandrel, sealing element, spacer ring, slip, wedge, retainer ring, extrusion limiter, backup shoe, mule shoe, tapered shoe, flapper, ball, ball seat, O-ring, sleeve, screen, wiper, enclosure, dart, valve, latch, actuator, actuation control device, or any combination. The resin-based material may form substantially the entirety of a wellbore tool. The wellbore tool may be any species of wellbore isolation device, frac plug, bridge plug, packer, wiper plug, cement plug, perforating gun, well screen tool, drilling tool, or any combination thereof. The resin may comprise a resin selected from the group consisting of shellac, a polyamide, a silyl-modified polyamide, a polyester, a polycarbonate, a polycarbamate, a urethane, a polyurethane, a natural resin, an olefin resin, an epoxy-based resin (e.g., epoxy-amine or epoxy-anhydride), a furan-based resin, a phenolic-based resin, a urea-aldehyde resin, a phenol-phenol formaldehyde-furfuryl alcohol resin, bisphenol A diglycidyl ether resin, butoxymethyl butyl glycidyl ether resin, bisphenol A-epichlorohydrin resin, bisphenol F resin, bisphenol S resin, diglycidyl ether of bisphenol F epoxy resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, or any combination thereof. The resin-based material may further comprise a hardening agent. The resin-based material may further comprise an accelerator.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A resin-based material comprising:
a resin; and
a boron nitride nanotube structure comprising a boron nitride nanotube having a hexagonal boron nitride structure epitaxial to the boron nitride nanotube.

2. The resin-based material of claim 1; wherein the boron nitride nanotube structure is dispersed in the resin with sonication.

3. The resin-based material of claim 1; wherein the resin-based material is a sealant used in a sealing operation in a wellbore.

4. The resin-based material of claim 1; wherein the resin-based material forms a component of a wellbore tool.

5. The resin-based material of claim 4; wherein the component is selected from the group consisting of mandrels, sealing elements, spacer rings, slips, wedges, retainer rings, extrusion limiters, backup shoes, mule shoes, tapered shoes, flappers, balls, ball seats, O-rings, sleeves, screens, wipers, enclosures, darts, valves, latches, actuators, actuation control devices, and any combination thereof.

6. The resin-based material of claim 1; wherein the resin-based material forms substantially the entirety of a wellbore tool.

7. The resin-based material of claim 6; wherein the wellbore tool is selected from the group consisting of: a wellbore isolation device, a frac plug, a bridge plug, a packer, a wiper plug, a cement plug, a perforating gun, a well screen tool, a drilling tool, and any combination thereof.

8. The resin-based material of claim 1; wherein the resin comprises a resin selected from the group consisting of shellac, a polyamide, a silyl-modified polyamide, a polyester, a polycarbonate, a polycarbamate, a urethane, a polyurethane, a natural resin, an olefin resin, an epoxy-based resin (e.g., epoxy-amine or epoxy-anhydride), a furan-based resin, a phenolic-based resin, a urea-aldehyde resin, a phenol-phenol formaldehyde-furfuryl alcohol resin, bisphenol A diglycidyl ether resin, butoxymethyl butyl glycidyl ether resin, bisphenol A-epichlorohydrin resin, bisphenol F resin, bisphenol S resin, diglycidyl ether of bisphenol F epoxy resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, or any combination thereof.

9. The resin-based material of claim 1; wherein the resin-based material further comprises a hardening agent.

10. The resin-based material of claim 1; wherein the resin-based material further comprises an accelerator.

11. A method comprising:
introducing a resin-based material into a wellbore, the resin-based material comprising:
a resin, and
a boron nitride nanotube structure comprising a boron nitride nanotube having a hexagonal boron nitride structure epitaxial to the boron nitride nanotube;
performing a wellbore operation in the wellbore with the resin-based material.

12. The method of claim 11, wherein the wellbore operation is a sealant operation.

13. The method of claim 12, wherein the sealant operation is a cementing operation and the resin-based material is used in place of or in addition to a cement.

14. The method of claim 11, wherein the wellbore operation is performed with a wellbore tool and wherein the wellbore tool comprises the resin-based material.

15. The method of claim 14, wherein the resin-based material substantially the entirety of the wellbore tool.

16. The method of claim 14, wherein the resin-based material comprises a component of the wellbore tool.

17. A system for performing a wellbore operation, the system comprising:
a resin-based material comprising:
a resin, and
a boron nitride nanotube structure comprising a boron nitride nanotube having a hexagonal boron nitride structure epitaxial to the boron nitride nanotube; and
a conveyance to introduce the resin-based material into a wellbore.

18. The system of claim 17, wherein the resin-based material is a sealant, and the conveyance is a pump configured to pump the resin-based material into the wellbore.

19. The system of claim 17, wherein the resin-based material forms at least a part of a wellbore tool and the conveyance is a wireline configured to transport the wellbore tool into the wellbore.

20. The system of claim 17, further comprising an ultrasonic sonicator configured to disperse the boron nitride nanotube structure in the resin.
